(19) United States
(12) Patent Application Publication
(10) Pub. No.: US 2023/0234190 A1
(43) Pub. Date: Jul. 27, 2023

(54) ADJUSTABLE FASTNER

(71) Applicant: Ryan Snodgrass, Lynd, MN (US)

(72) Inventor: Ryan Snodgrass, Lynd, MN (US)

(21) Appl. No.: 17/583,424

(22) Filed: Jan. 25, 2022

(51) Int. Cl. B25B 13/48; B25B 13/02; F16B 39/24; A01K 63/00

(52) U.S. Cl. CPC B25B 13/48; B25B 13/02; F16B 39/24; A01K 63/006

(57) ABSTRACT

An adjustable locking fastener comprising a post and a lever for use in an aquarium. The adjustable locking fastener includes a post, a lever and a letoff portion. The adjustable locking fastener may be quickly removed and reattached with minimal effort, and with a constant set point for the attachment.

### BACKGROUND OF THE INVENTION

### Field of the Invention

The invention relates to a quick release adjustable locking fastener for use in the aquarium industry.

### Background Art

The present invention relates to aquaria and in particular to an adjustable locking fastener with a quick release mechanism. Aquarists have many pieces of equipment that are preferably water tight, and thus must be sealed, but also need to be maintained or cleaned. Thus, there is a need in the aquarium industry for fasteners that provide quick access to the interior of the equipment for cleaning, parts replacement, operational adjustment, and the like, while also providing a reliable and water tight seal.

However, due to the water—or saltwater—exposure to the equipment, the materials used can also be important, depending on the position of the equipment. The equipment itself may be designed of water resistant material, such as plastics, especially food grade plastics, PVC, ABS, stainless steel, epoxies, silicon, acrylics, PET, PTFE, Nylon, etc. Thus, the fastener must be designed to work with such materials. In particular, over tightening a fastener can lead to many of these materials shattering under pressure. Thus, the fastener is preferably capable of a precise adjustment without overtightening.

Current fasteners may be made of materials suitable for use in the aquarium, but can be very time consuming to remove and reengage. Thus, it would be advantageous to have an adjustable locking fastener for use in the aquarium industry.

### BRIEF SUMMARY OF THE INVENTION

The present invention solves these needs by providing a quick release adjustable locking fastener that includes a bolt and a socket wrench.

In one embodiment, the invention includes an adjustable locking fastener for use in an aquarium. The fastener includes a post of aquarium safe materials and including a shaft and a head. The fastener further includes a lever with a first and a second protrusion with a gap between them, the gap sized to accommodate the post, a first raised portion, a second raised portion, and a depression between the first and second raised portion, the depression sized to accommodate the head, and a letoff portion.

In another embodiment the adjustable locking fastener has a leftoff portion that is rounded. In another embodiment the adjustable locking fastener has a letoff portion that is flat. In one embodiment the flat letoff portion has a different axis than the lever.

In one embodiment the post and the lever are constructed of a reef safe material. The reef safe material can be injection molded plastic. The reef safe material may fluoresce under UV light.

In one embodiment the head includes a tightening means. The head may also include a recess. In another embodiment the depression is sized to hold the head. The depression may be shaped to provide a letoff when the head is fully seated inside the depression. The depression may surround the head, or may partially surround the head.

In on embodiment the lever is configured to rotate from a first position to a second position. In another the lever is configured to increase the tension on the post as it rotates from a first position to a second position. The letoff portion can be configured to reduce the tension on the post at the end of a lever rotation.

In another embodiment the adjustable locking fastener includes a post, the post constructed entirely of aquarium safe materials and comprising a shaft and a head, as well as a lever that has a first and a second protrusion with a gap between them, the gap sized to accommodate the post, a first raised portion, a second raised portion, and a depression between the first and second raised portion, the depression sized to accommodate the head; and a letoff portion, wherein the letoff portion is configured to retain a constant tension on the post during a portion of a lever rotation. In another embodiment the lever comprises a detachable tool, the detachable tool being configured to tighten or loosen the post.

### BRIEF DESCRIPTION OF THE DRAWINGS

FIG. 1 is a partial perspective view of a prior art thumbscrew fastener;

FIG. 2 is a partial perspective view of a post of the present disclosure;

FIG. 3 is a partial perspective view of a post of the present disclosure;

FIG. 4 is a partial perspective view of a lever of the present disclosure;

FIG. 5 is a partial perspective view of a lever of the present disclosure engaging the post of the present disclosure;

FIG. 6 is a partial perspective view of a post of the present disclosure on an aquarium device;

FIG. 7 is a partial perspective view of an aquarium device, a lever, and a post of the present disclosure with the lever in the open position.

FIG. 8 is a partial perspective view of an aquarium device, a lever, and a post of the present disclosure with the lever in the closed or locked position.

FIG. 9 is a top perspective view of a post and lever of the present disclosure in the closed or locked position.

FIG. 9a is a side perspective view of a post and lever of the present disclosure in the closed or locked position.

FIG. 10 is a partial perspective view of a lever and a post of the present disclosure with the lever in the closed or locked position.

FIG. 11 is a cutout view of a lever and a post of the present disclosure with the lever in the closed or locked position.

FIG. 12 is a partial perspective view of a lever of the present disclosure;

FIG. 13 is a partial perspective view of a post of the present disclosure;

FIG. 13a is a top perspective view of a lever of the present disclosure that accompanies the post of FIG. 13;

FIG. 13b is a partial top perspective view of the post of FIG. 13 with the lever of FIG. 13a, in an open position.

FIG. 13c is a partial top perspective view of the post of FIG. 13 with the lever of FIG. 13a, in a closed position.

FIG. 14 is a partial perspective view of a post of the present disclosure;

FIG. 15 is a partial perspective view of a lever and post of the present disclosure;

FIG. 16 is a partial perspective view of a post of the present disclosure;

FIG. 17 is a partial perspective view of a post of the present disclosure;

FIG. 17a is a side view of a lever of the present disclosure that accompanies the post of FIG. 17;

FIG. 18 is a partial perspective view of a lever of the present disclosure;

FIG. 18a is a partial perspective view of a post of the present disclosure that accompanies the lever of FIG. 18;

FIG. 18b is a partial perspective view of a lever of the present disclosure;

FIG. 18c is a partial perspective view of a post of the present disclosure that accompanies the lever of FIG. 18b;

FIG. 19a is a partial perspective view of a post of the present disclosure;

FIG. 19b is a partial perspective view of a post of the present disclosure;

FIG. 19c is a partial perspective view of a post of the present disclosure;

FIG. 19d is a partial perspective view of a post of the present disclosure;

FIG. 19e is a partial perspective view of a post of the present disclosure;

FIG. 19f is a partial perspective view of a post of the present disclosure;

FIG. 19g is a partial perspective view of a post of the present disclosure;

FIG. 19h is a partial perspective view of a post of the present disclosure;

FIG. 20a is a partial perspective view of a lever of the present disclosure;

FIG. 20b is a partial perspective view of a lever of the present disclosure;

FIG. 20c is a partial perspective view of a lever of the present disclosure;

FIG. 20d is a partial perspective view of a lever of the present disclosure;

FIG. 20e is a partial perspective view of a post and corresponding lever of the present disclosure;

FIG. 20f is a partial perspective view of a lever of the present disclosure;

FIG. 20g is a partial perspective view of a lever of the present disclosure;

FIG. 20h is a partial perspective view of a lever of the present disclosure;

FIG. 20i is a partial perspective view of a lever of the present disclosure;

FIG. 20j is a partial perspective view of a lever of the present disclosure;

FIG. 21 is a partial perspective view of a lever of the present disclosure;

FIG. 22 is a partial perspective view of a lever of the present disclosure;

FIG. 23 is a partial perspective view of a lever of the present disclosure;

### DETAILED DESCRIPTION OF THE PREFERRED EMBODIMENTS

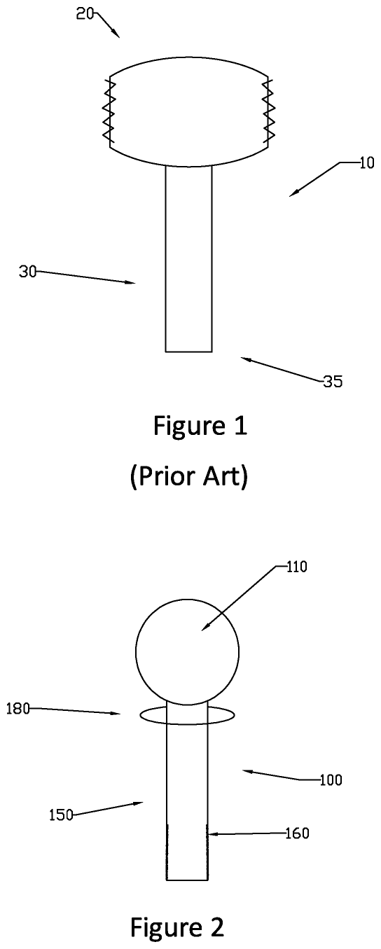

FIG. 1 demonstrates one type of prior art fastener known in the aquarium industry, a nylon thumbscrew of the type often used in the aquarium industry to connect removable portions of an aquarium device, such as a skimmer, RODI canister, calcium reactor, or the like. The thumbscrew 10 includes a head 20. The head 20 may be knurled or otherwise adapted to provide a grip for the user to turn via finger pressure. The shaft 30 is attached to head 20, and is threaded 35 for screwing into a receiving portion of the device. In use, the top of a canister (not shown), for example, will include a removable lid (basically a disk) that has holes in it. The thumbscrew is threaded or placed through those holes, and into the body of the canister, where it is screwed into a threaded hole. Once screwed into place, the thumbscrew (typically several thumbscrews) hold the canister lid onto the canister, making the device water tight. When the thumbscrews are removed, the canister lid can be removed and the canister can be cleaned.

While the thumbscrew can provide a reliable attachment, it can also prove tedious to use, requiring the user to screw the thumbscrew all of the way in and out each time the equipment is to be used. As many types of equipment require a dozen or more attachment points to even out the pressure across a broad surface, their use can become a chore that causes the aquarist to skip maintenance, or face the sore thumbs from screwing each of the screws in and out.

The thumbscrews can also be a failure point, as over tightening by the user is common, as is the presence of salt creep, scale, or other fouling making it hard to remove the device without snapping the screw. Likewise, some materials, such as nylon, can absorb water or expand in water. If the holes are not over drilled the screw can expand and be hard to impossible to remove. If the holes are over drilled, the threading is more likely to strip or fail.

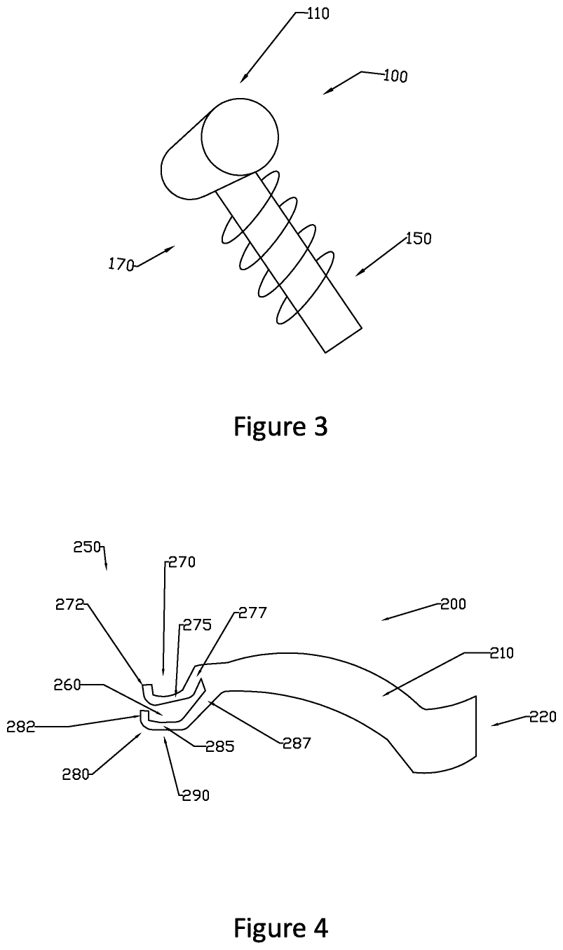

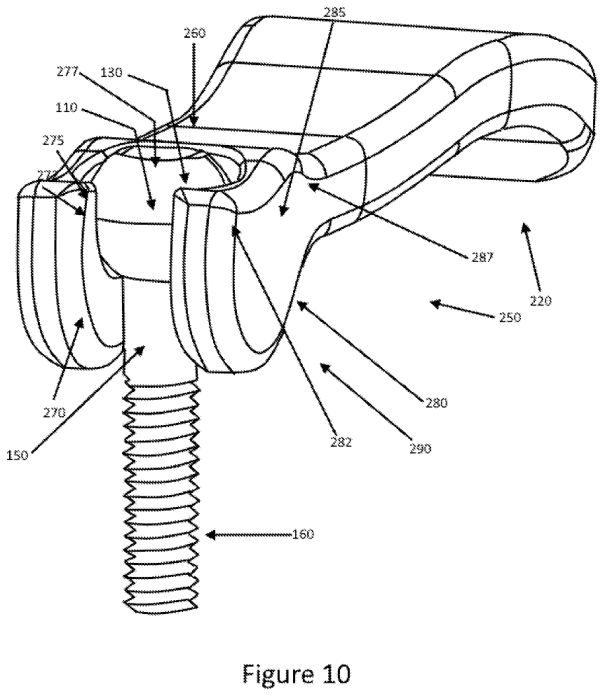

Thus, there is a need for a reliable, easy to remove and easy to lock in place fastening system for aquarium devices. The present invention consists of an aquarium device with a fastening system. The fastening system has two main portions. First, as illustrated in FIG. 2 the adjustable fastener includes a post 100. The post 100 includes a head 110 and a shaft 150. In the embodiment shown in FIG. 2, the shaft 150 includes threads 160. Head 110 may include a turning mechanism. For example, head 110 may be knurled, for finger turning, or may include a socket or a receptacle 130, a Philips head receptacle, flat head, or Allen wrench receptacle (see FIG. 10), preferably on the top. In use, for example, an Allen wrench is used to set the depth of the post in the aquarium device. In an alternative embodiment, shown in FIG. 3, the post 100 may include a smooth shaft 150. As discussed herein the shaft may be preattached, or formed as a part of, one or more portions of the aquarium device. In this case, its depth may be preset, and thus not adjustable by the user. In the alternative, or in addition to the lever and letoff discussed herein, the shaft may include a tensioning device, such as a leaf spring, a coil 170 (FIG. 3), a spring, a spring washer, a compressible washer or compression layer. The tensioning device is preferably attached to the post 100, such that even if post 100 is removed from the aquarium device entirely, the tensioning device will remain with the post 100. In an alternative embodiment, the tensioning device is attached to a portion of the aquarium device rather than to the post 100, or is removable entirely.

The post may be formed from metal, may be 3D printed, or otherwise formed. Likewise, lever 200 may be similarly formed.

In one embodiment, as shown in FIG. 2, the post includes a washer 180. The washer 180 acts to spread out the force on the aquarium device, to reduce cracking or damage to the larger unit by excessive tension. In one embodiment the washer is an integral part of the shaft 150. In another, it is a separate device. The washer can be the same or a different material. Preferably, the washer is prevented from separating from the shaft 150, e.g. via a washer clip. In another embodiment the washer is built into the body of the aquarium device.

The head 110 is preferably rounded. As shown in FIG. 2, head 110 in one embodiment is spherical. As shown in FIG. 3, head 110 may also be cylindrical. In other embodiments, the head 110 may be triangular, egg shaped, or otherwise shaped. In each case, the shape of the head is designed to match that of the lever, discussed herein, so that the two portions match.

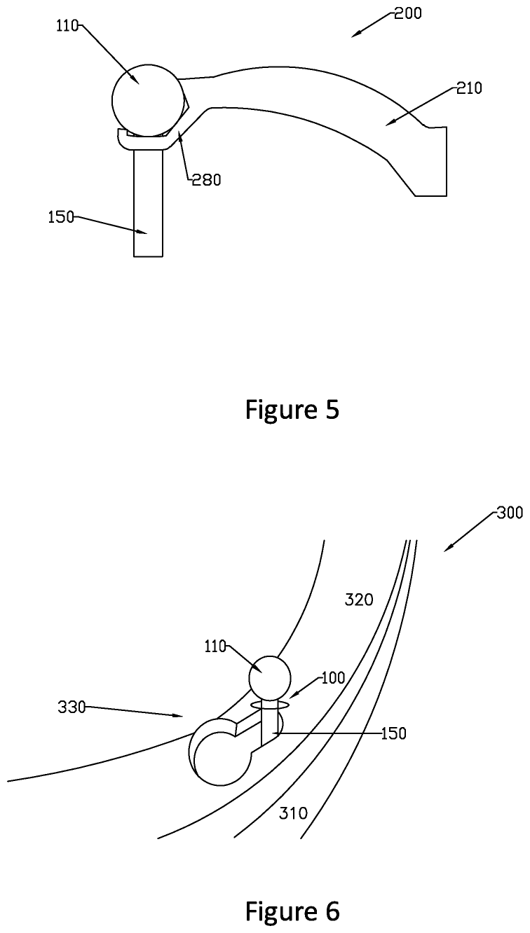

The second portion comprises the lever, as shown in FIG. 4. The lever 200 comprises an operating end 210 and a post end 250. The operating end may be curved 220 upward at its distal or outer end to allow for easy handling when in the closed position, where the bottom part of operating end 210 may be in contact with the aquarium device. The curved portion 220 allows the user to reach underneath the lever 200 to raise it. The post end 250 includes a gap 260 adapted to receive the head 110 of the post 100. For example, as shown in FIG. 4, the post end 250 may include a first protrusion 270, and a second protrusion 280. The first and second protrusion include gap 260 between them, and are at least as wide as shaft 150, such that shaft 150 may fit between them, as shown in FIG. 5. Gap 260 may be sufficiently sized that a portion of head 110 may fit inside gap 260 as well. First and second protrusions 270, 280 each include a depression 275, 285 in a middle portion, and include raised portions 272, 282 on the outer most end of the protrusions 270, 280. Protrusions 270, 280 further include a raised portion 277, 287 toward the inner end of the protrusions.

In one type of fastener, lever 200 is designed so that as it's moved from its open position (e.g., up, as in one embodiment) to its closed position (e.g., down) it lifts the post 100 farther up, or places an increasing tension on the post. However, to lock the lever in the closed position, there is a “letoff.” In a preferred embodiment the “letoff” is a reduction in tension at or near the end of the rotation. This tension reduction holds the lever in that locked positions. As shown in FIG. 4, a cross section of the lever, the lever includes a tension letoff portion 290. In this embodiment the tension letoff portion is a flat portion. When the lever reaches the flat portion the tension undergoes a slight reduction, such that opening the lever first requires a small force to lift the lever past that letoff (and thus briefly increasing the tension) before the lever is fully opened. In the absence of a force applied by the user, the lever will stay with the flat portion in contact with the aquarium device.

In the embodiment depicted in FIG. 4, lever 200 is not permanently affixed to post 100, and may be removed therefrom.

In operation, post 100 is threaded into or otherwise attached to a first portion 310 of an aquarium device 300, a portion of which is shown in FIG. 6. The first portion 310 will include a hole or attachment point (not shown). Shaft 150 of post 100 is threaded into the first portion 310 to the desired depth. In a preferred embodiment, the depth can be adjusted as needed, as discussed above. A second portion 320 of aquarium device, such as a canister lid 320, will be placed over and secured to the first portion 310 using the adjustable attachment device. The second portion 320 may include a keyhole 330 such that the second portion can be placed over the first portion while the post 100 is at least partially in place. The second portion is then rotated so that the shaft 150 is in the smaller diameter section of the keyhole. In other embodiments, the second portion has a hole barely wider than post 100, and is placed on the first portion 310 before the post 100 is threaded into position.

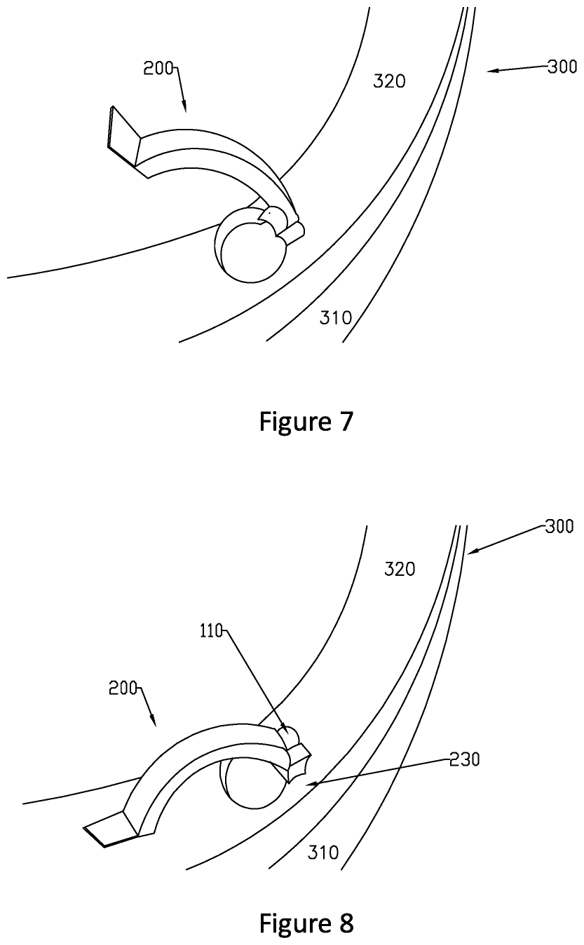

Once the post 100 is threaded to the desired depth, the lever 200 is placed around the post 100, such that protrusions 260, 270 are between the second portion 320 and the head 110. See FIG. 7. In this step, the lever 200 is typically oriented upward. In a second embodiment—not shown—the lever 200 is initially placed around post 100, but is flat, or parallel to the second portion 320. In either case, the lever is not yet putting the post under significant tension to lock the first and second portions of the aquarium device together. As shown in FIG. 8, the lever may then be lowered (or raised, depending on the embodiment) to place the post under tension, locking the first and second portions 310, 320 together.

To separate the first and second portions for maintenance or cleaning the lever 200 is then raised back to the position shown in FIG. 7. In some embodiments the lever can then be removed, and the second portion 320 of the aquarium device may be removed from the first portion 310. In these embodiments there may be one lever for each post 100, or there may be a single lever for all of the posts 100, where the lever locks the post in place and then may be removed and used on the next post. In other embodiments, the lever is shaped or sized such that it may pass through the key hole in the second portion as the second portion is removed. Thus the second portion can be quickly and easily be removed, and then placed back into position.

The lever puts the post under tension by its shape. As shown in FIG. 5 the lever 200 includes a curved bottom edge of its distal most portion. This curve allows raised portions 272, 282 to fit under the head 110 of the post. As the main body 210 of the lever is lowered more of the lever fits under the head 110, and the head 110 moves into the depression 275, 285. The head 110 is then held into the depressions 275, 285 as it fits between the more distal raised portions 272, 282 and the more proximal raised portion 277, 287. The lever locks into position due to, in one embodiment, the presence of a letoff portion, in this case flat portion 230 on the bottom edge under the depressions 275, 285.

In practice, the highest amount of tension on the post 100 is just before the lever is flat (or fully raised in the second embodiment, above). So, for example a cam style lever 200 (See FIG. 10) in which the center point of the rotation is off center may increase pressure by rotating to a thicker and thicker portion of the lever (or in other embodiments, of the head 110). At the end, the rotation brings the head to a slightly thinner portion of the cam, reducing the tension. The thinner portion may be a slightly thinner portion of the cam, or may be a flat portion 230 (FIG. 4). Once the lever is fully flat—and thus the flat portion 230 is in contact with the aquarium device, typically at layer 320, —the tension lets off slightly, locking the shaft into position. While lever 200 is depicted as having a flat portion, other shapes are contemplated. In particular, the distal portion of the lever may have an egg shaped end, and thus again the tension on the post is raised until just before the locking position. As it finishes into the locking position the tension is reduced, and holds lever in place. The lever stays in the locked position as it would require an increase in tension on the post to move it back up, and this will only happen when the user acts on the lever.

The amount of letoff will depend on the needs of the aquarium device. For example, how tightly the aquarium device must be sealed. A device under significant pressure may need to be sealed very tightly. A device that will be located inside the aquarium, or in water, where leaks will not be significant, may be very loosely sealed. In one embodiment the letoff ranges from 0.1 mm to 0. In another embodiment the letoff range includes 0.2 mm to 0.001 mm. In a preferred embodiment the letoff ranges from 0.001 mm to 0.01 mm. The presence of tensioning members may also impact the letoff. So for example, if the post includes a spring (See FIG. 3) the letoff can be more significant as the spring may maintain the pressure holding layers 320, 310 together through a larger letoff.

Many such aquarium devices will include a gasket between the layers (not pictured). The gasket may be a band that fits into a groove between the layers, or a flat, flexible layer between layers 320, 310. If so, the letoff amount will depend on how much the gasket compresses. A very soft gasket will compress more, and allows for a larger letoff. In a preferred embodiment the aquarium device includes a 1 mm gasket, and thus the letoff is smaller, such as 0.01 mm, or preferably 0.001 mm. In no case should the letoff be larger than the gasket is wide, unless another tensioning member is present (e.g., a spring).

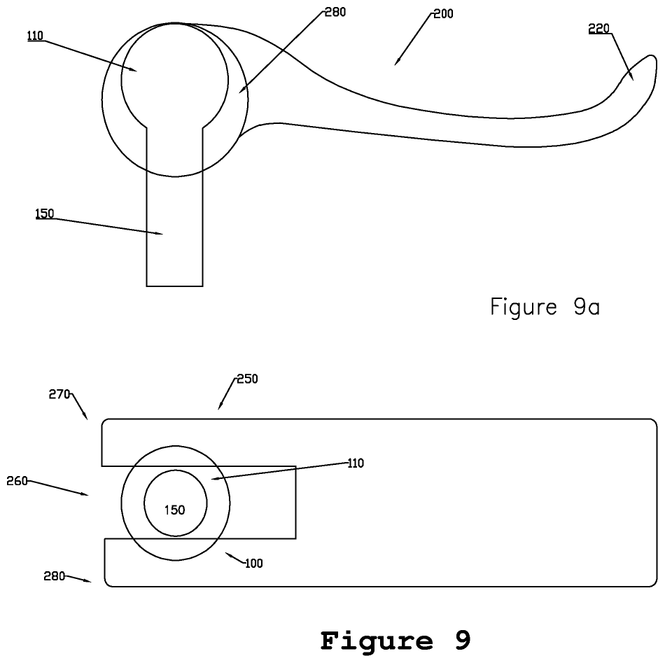

In a second embodiment, shown in FIG. 9, the lever may include protrusions 270, 280, with a post end 250. The post end 250 includes a gap 260 adapted to receive the head 110 of the post 100. For example, as shown above in FIG. 4, the post end 250 may include a first protrusion 270, and a second protrusion 280. The first and second protrusions include gap 260 between them that is at least as wide as shaft 150, such that shaft 150 may fit between them, as shown in FIG. 5 and FIG. 9.

As shown in FIG. 10, gap 260 may be sufficiently sized that a portion of head 110 may fit inside gap 260 as well. First and second protrusions 270, 280 may include a depression 275, 285 in a middle portion. However, in another embodiment, the gap 260 is shaped and sized to hold head 110, and or a portion of shaft 150, and the depressions 275, 285 are not required. The protrusions 270, 280 may include raised portions 272, 282 on the outer most end of the protrusions 270, 280. Protrusions 270, 280 may further include a raised portion 277, 287 toward the inner end of the protrusions.

In the embodiment of FIG. 9a, the lever further includes shroud 280, which wraps around head 110. Shroud 280 may fully encapsulate head 110, holding lever 200 and post 100 together so that they are not readily separated. Shroud 280 may partially encapsulate 110.

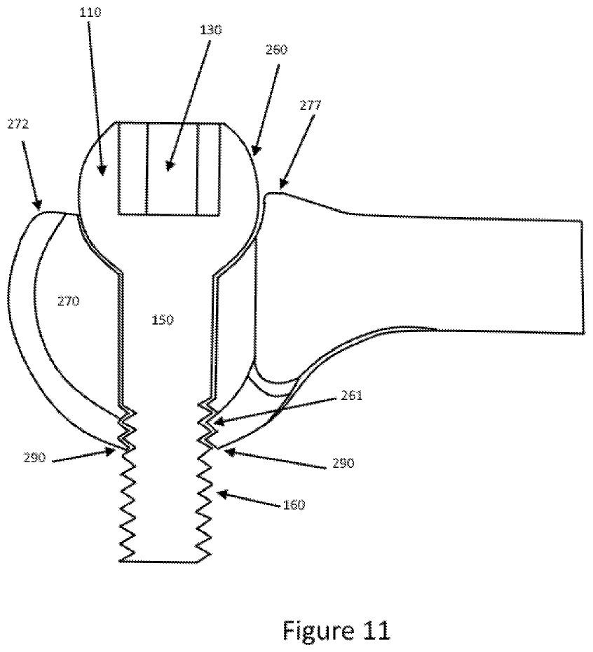

As shown in FIG. 11, lever 200 may include threading 261 in gap 260. Threading 261 may match the threading 160 on shaft 150, such that in operation threading 160 may go both into aquarium device portion 310 and into lever 200, holding the system together. Likewise, the threading 261 may hold the lever 200 and bolt 100 together, such that they can be separated, but unless specifically removed by the user, the lever stays with the bolt.

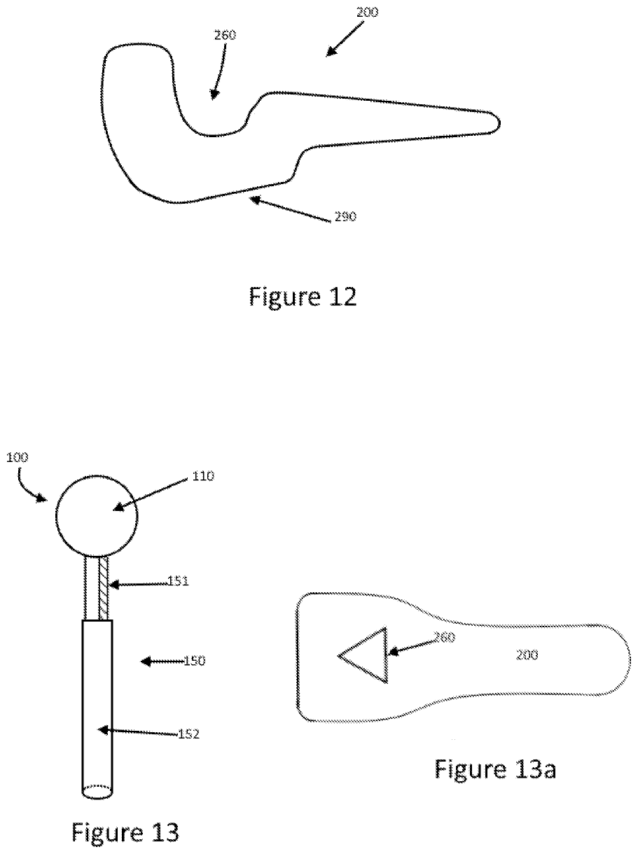

In one type of fastener, lever 200 is designed so that as it's moved from its open position (e.g., up, as in one embodiment) to its closed position (e.g., down) it lifts the post 100 farther up, or places an increasing tension on the post. However, to lock the lever in the closed position, there is a “letoff.” In a preferred embodiment the “letoff” is a reduction in tension at or near the end of the rotation. This tension reduction holds the lever in that locked positions. As shown in FIG. 4, a cross section of the lever, the lever includes a tension letoff portion 290. In this embodiment the tension letoff portion is a flat portion. When the lever reaches the flat portion the tension undergoes a slight reduction, such that opening the lever first requires a small force to lift the lever past that letoff (and thus briefly increasing the tension) before the lever is fully opened. In the absence of a force applied by the user, the lever will stay with the flat portion in contact with the aquarium device. In the embodiment of FIG. 10, the tension letoff 290 portion is the bottom of the egg shaped portion. As shown in FIG. 12, the tension letoff portion may be similar to the flat version of FIG. 4, but instead of flat it may be sloped.

As shown in FIGS. 1-8, the lever protrusions 270 280 are straight and parallel. In another embodiment, the lever protrusions are curved to reach around the shaft 150. In still another embodiment the lever protrusions are straight, but not parallel, such that the gap forms a triangle. In such a case, the gap would ideally match the shape of the shaft at the location the two come in contact. For example, for a triangular gap the shaft could be triangular. The shaft could also be square, but be turned so that one corner of the shaft is oriented into the vertice of the triangular gap. In preferred embodiment the shaft is round for a majority of its length, and only forms a different shape in the region it intersects with the lever. As shown in FIG. 13, the shaft 150 may have a shaped portion 151 (triangular as shown, or square, hexagonal, etc.) at its top end near head 110, and a cylindrical portion 152 (or another cross sectional shape) in the portion that enters the aquarium device. As shown in FIG. 13a, the gap 260 would then match the shape of shaped portion 151. In use, as shown in FIG. 13b, the fastener 100 is placed through the gap 260 in the lever 200, and into the aquarium device. For example, it could be threaded to the desired depth. At this point, the lever 200 is rotated, as shown in FIG. 13c, so that gap 260 mates with shaped portion 151, allowing a tension “letoff.” In this embodiment the triangular shaft portion 151 is preferably shorter than that pictured in FIG. 13, so that the letoff is shorter.

Thus, in this embodiment the bottom of the lever does not provide the lefoff, but rather the mating of the gap 260 with the shaped portion 151 provides a letoff when it reaches the locking position.

In this case the tension letoff may alternatively allow for easy removal of a portion of the aquarium device, or it may allow for locking the shaft in position. In the embodiment that allows for easy removal at the point where 151 and 260 match, the lever is rotated until they match. At this point the triangular shaft portion 151 shown in FIG. 13, matches exactly with the triangular gap 260 in FIG. 13a, and due to that match the post can slide down into the gap, releasing the tension. The triangular shaft portion may be longer (see FIG. 13) in order to allow a longer release distance. In this case it is preferred that at least one side or face of the triangular shaft portion extend beyond the outer surface of the cylindrical shaft section 152.

In one embodiment, the gap 260 has multiple layers. Rotating the lever in one direction may force the shaped portion up a sloped surface to increase the tension, until it fits exactly into a depression in gap 260, locking the shaft into place.

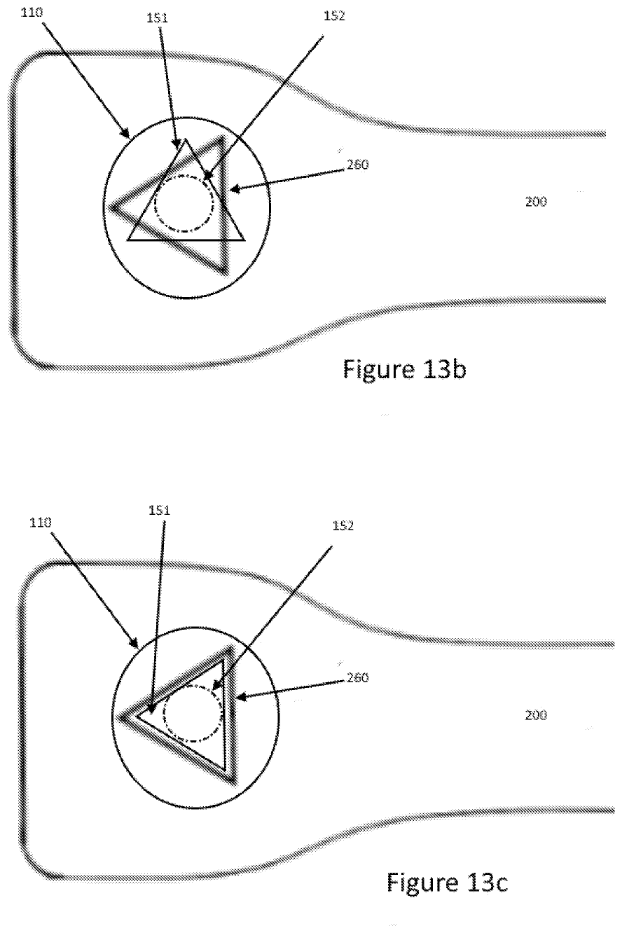

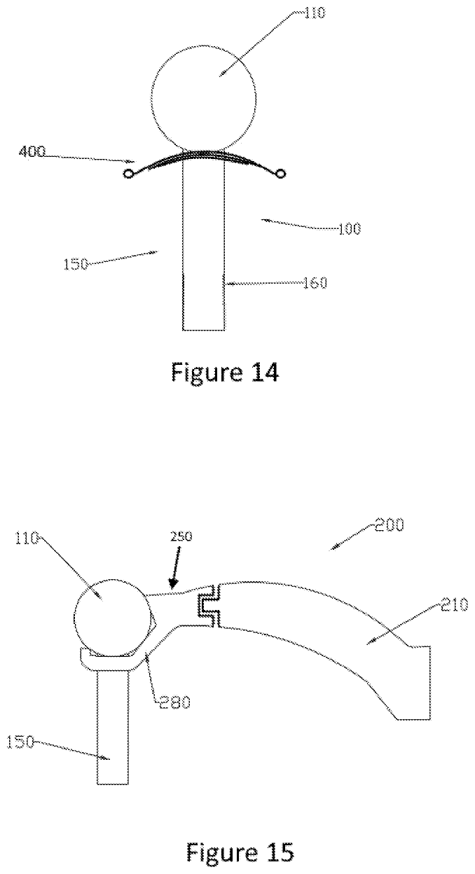

In one embodiment, the adjustable locking fastener further comprises a tensioning element. For example, as shown in FIG. 14, the fastener may include a spring 400. One advantage of a spring is to provide a constant level of tension. When using various plastic or polymer materials—common in the aquarium industry—over tensioning can easily strip screw threads, crack materials, etc. The use of a spring to provide a constant tension allows the user to have flexibility in how far into the aquarium device the post 100 is inserted, without overly increasing the tension. In addition, a spring 400 allows the locking mechanism to work past its highest tension level into its locking position without cracking the materials. In other embodiments the tensioning member may be a leaf spring, a coil 170 (FIG. 3), a spring washer, a compressible washer or compression layer 410. Multiple tensioning members may also be provided, for example a spring on post 100, and a compression layer or seal between the two portions of the aquarium device.

The adjustable locking fastener may further include a locking mechanism to prevent accidental dislodgement. For example, a spring loaded pin may fit from the lever through a detent in the head. The pin must be depressed and released before the lever may be raised, opening the device.

In another embodiment, shown in FIG. 15, the lever comprises a first portion and a second portion, the first and second portions being separable. In this embodiment, the first portion comprises the operating end 210, and once the post end 250 has locked onto the shaft and is in position to hold the aquarium device, the operating end is removed, leaving the second portion (post end 250) in place to lock the aquarium device together. The portions may be joined via a friction fit of closely mated portions, screwed together, latched together, or otherwise.

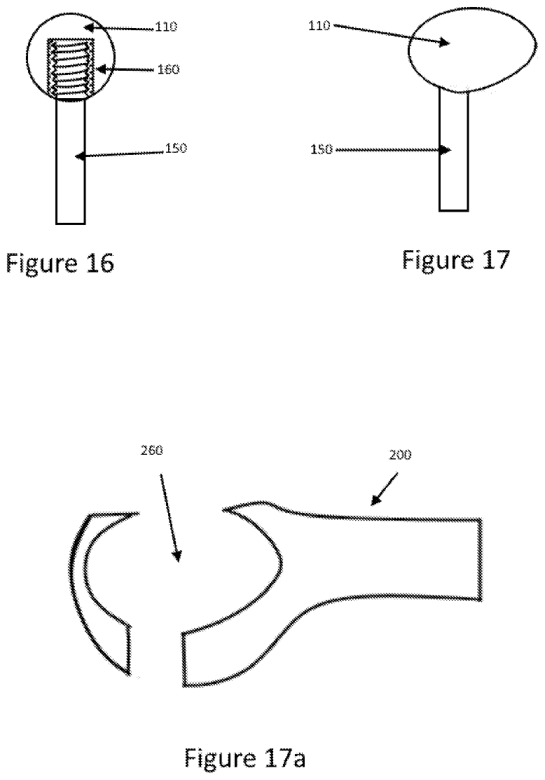

Similarly, as shown in FIG. 16, the post may be comprised of a first portion and a second portion. For example, in FIG. 16 the ball 110 is threaded onto the post 150.

In another embodiment the post 100 may have an egg shaped head 110 on top of post 150. The lever 200 then has an egg shaped gap 260 matching head 110. In the embodiments discussed for FIGS. 1-12, the letoff is typically found at the meeting of the bottom of the lever and the top of the aquarium device. As in FIG. 13, however, the letoff may be between the post and the lever. Likewise, in FIG. 17, the addition of lever 200 to post 100 uses the relationship between egg shaped head 100 and egg shaped gap 260 to first increase the tension on the post, holding the aquarium device in a locked position, and then to provide the letoff that locks the device into position.

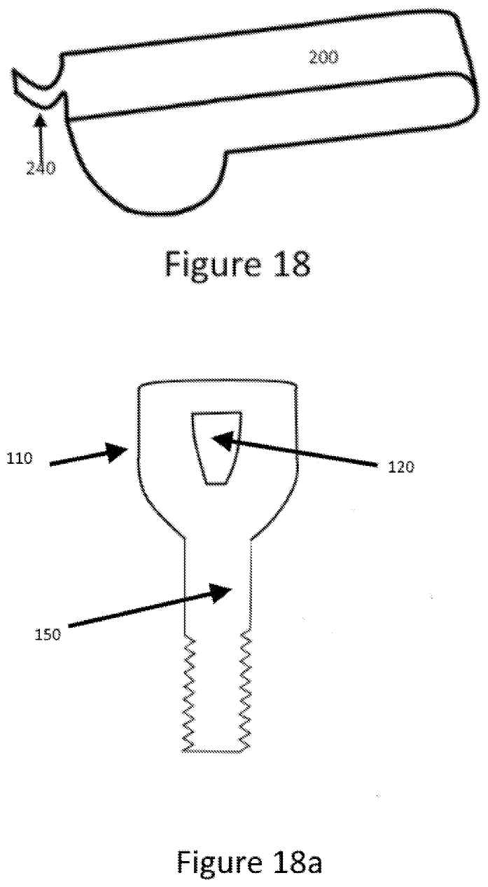

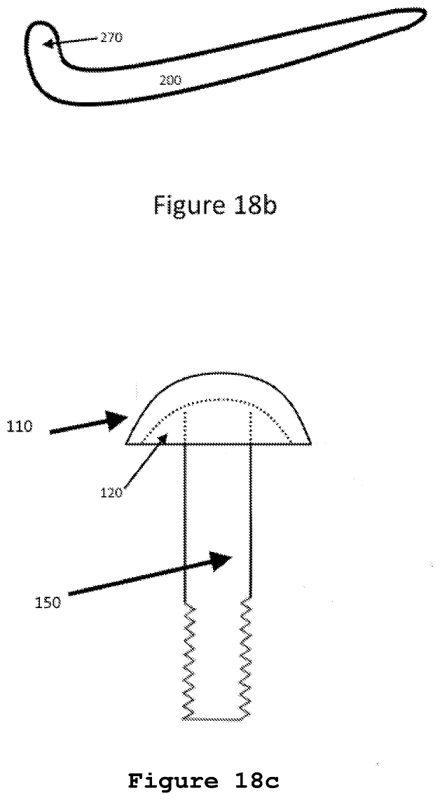

Similarly, while above most embodiments show a gap 260 that holds head 110, in FIGS. 18 and 18a, lever 200 may have a protrusion 240 that fits inside a gap 120 of head 110 of the post 100. The protrusion raises head 110 when lever 200 is lowered into position, placing tension on the post and holding the aquarium device in a closed position with portions 310 and 320 sealed shut, for example. FIG. 18b shows a lever shaped like a swoosh. FIG. 18c shows a post with a head 110 that is shaped like a mushroom, with space 120 underneath its outer edges for the lever 200's distal portion 270 to fit within. When the lever is lowered the protrusion rises into the space 120, forcing the post up and into tension, locking the aquarium device in place.

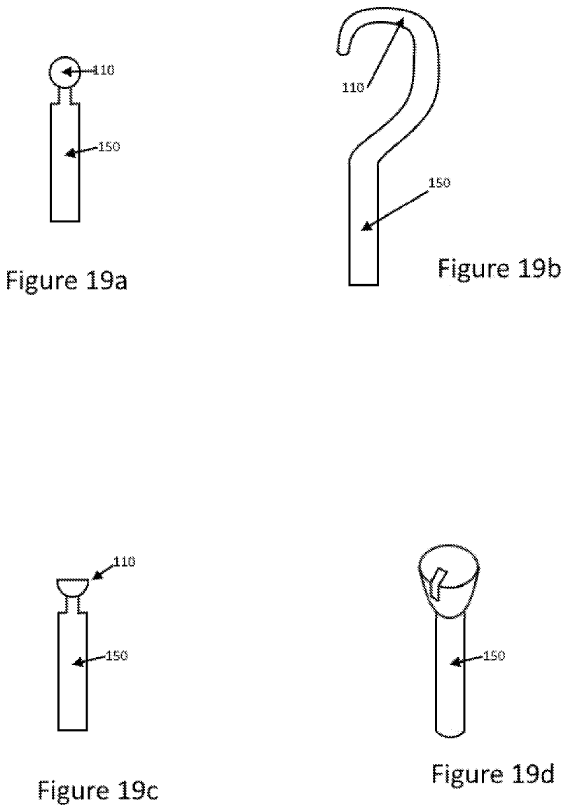

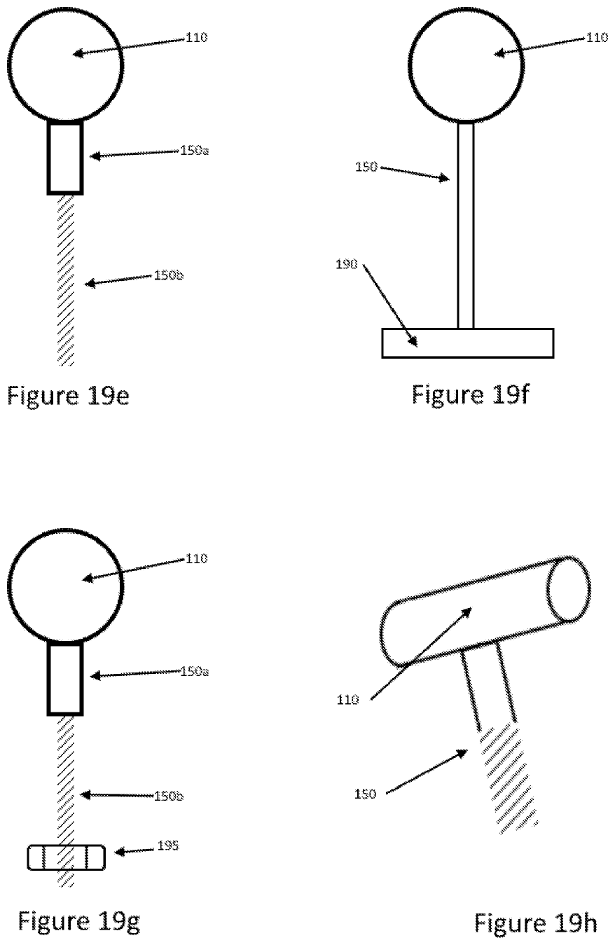

FIGS. 16, and 19 a-i show additional post embodiments. While many of the additional post embodiments function largely as the posts described above, there can be differences. FIG. 19b, for example, presents a hook that could work with a number of the levers disclosed herein, but it can also be tightened by the lever of 18a. The post of FIG. 19d provides a key slot for tightening, the key is inserted into the slot, and used to screw or otherwise adapt the post into position. FIG. 19e presents a post with two shaft portions 150a is wider, while 150b is thinner. This can be useful in saving material, allowing the post to be inserted into thinner walled materials on the aquarium device, or simply reducing the friction for screwing 150b into the aquarium device. FIG. 19g depicts a similar embodiment that further comprises a bolt 195, which can be stationary (e.g., fixed in place on the aquarium device such that the post is tightened into the bolt from above) or which could be used to tighten the post into place by turning the bolt from below. The shaft could include multiple portions 150a, 150b as shown in FIG. 19g, or just one portion.

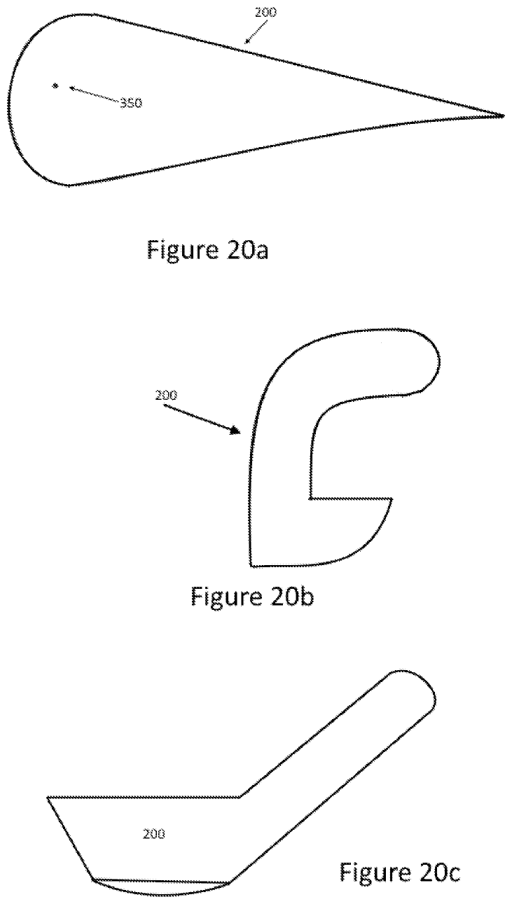

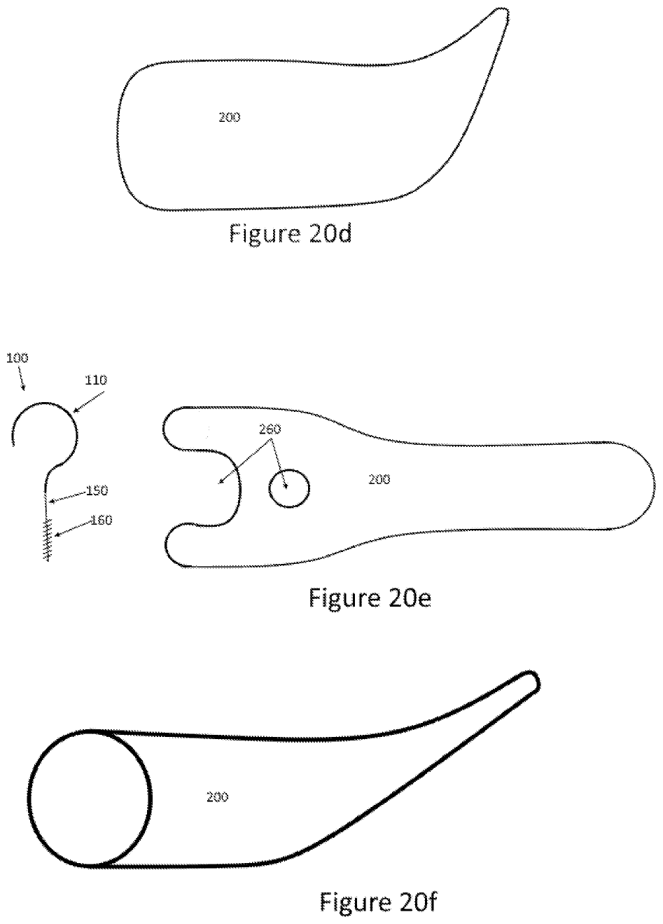

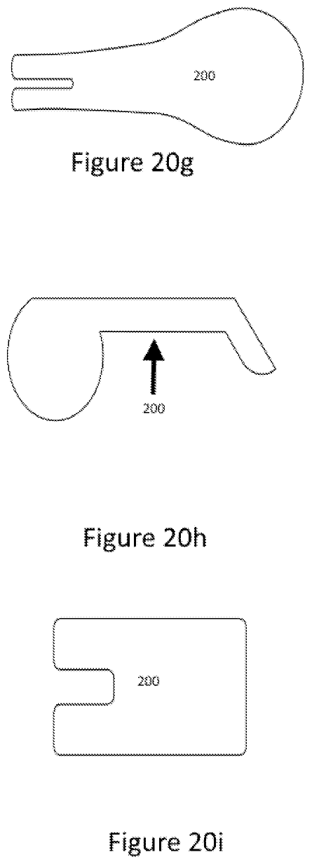

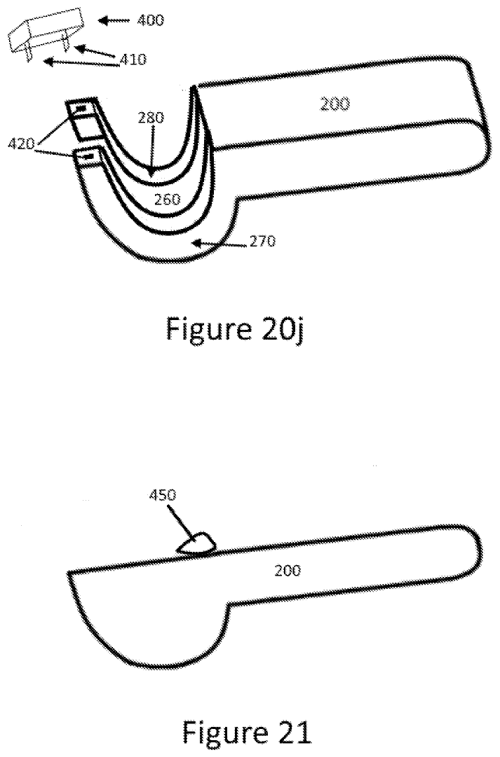

FIG. 19f shows a post embodiment that can be tightened from below. In this embodiment the post includes a head 110, a shaft 150, and a base 190. In use the shaft or base can form into a T or a hex base to lock the post in place and apply pressure from underneath. FIG. 19h shows a post with a cylinder head that would work well with the lever of FIG. 20j. the post of FIG. 19h's head 110 is readily used to screw the shaft to the proper depth by the user grasping the cylinder 110. The cylinder is then easily rotated until the shaft is at the proper depth. The arms 270, 280 of FIG. 20j will be spaced to allow the shaft 150 between them. The cylindrical 110 then fits into the gap 260 in arms 270, 280, and can be placed under tension to close the aquarium device. In one embodiment the protrusions 270, 280 and gap 260 may form a circle around the circumference of the cylinder 110, leaving the bases (the ends) exposed (not pictured). In one embodiment a pin 290 runs through the axis of the cylinder and the head 110 or shaft 250, permanently connecting the lever and the post 100.

FIGS. 20a-j show additional lever embodiments. Various combinations may be made. As shown in FIG. 20e, the lever 200 may have multiple gaps for differing purposes. For example, a smaller gap 260 may be used to slide the hook 110 of FIG. 20e through the enclosed gap, e.g., a circular gap. The lever 200 is then rotated, causing the post to rotate, and screw into position at the proper or desired depth. The lever 200 is then removed, and the post 100 is placed in a different gap 260, the lever is lowered to its locking position, raising the post and placing the parts of the aquarium device under tension.

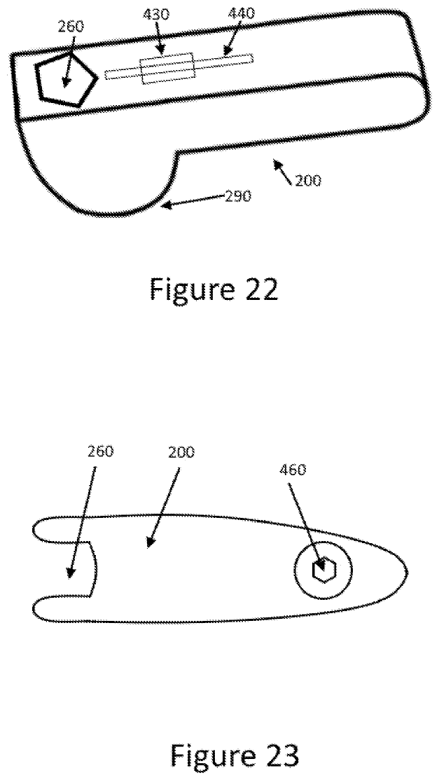

As shown in FIG. 20j, the lever 200 may include a clip 400 that latches in place on lever 200 or head 110 to prevent the lever from moving or from breaking under stress. The clip 400 may have inserts 410 that fit into spaces 420 on arms 270, 280 of lever 200. As shown in FIG. 21, the lever 200 may include a raised portion, e.g., a rubber nubbin 450 to snap the bolt into place and hold it from rotation. A detent or pin may do the same. Likewise, as shown in FIG. 22, a covering 430 that may rotate or slide into place along a track 440 may also hold the post into place.

As shown in FIG. 23, the lever may include a device to directly turn the post for raising or lowering its position. For example, the lever 200 may include a hex bit 460 on its bottom side as pictured in FIG. 23. The hex bit may also be on the top side, one of the legs 270, 280, on the tail end, or a side. Instead of a bit, 460 may be a socket or receptacle for a hex on the post, or may be any other format used to mate with the post for turning it, raising or lowering it.

In some embodiments the “lefoff” may simply be a position that maintains the exact tension, without increasing it. That is, if the tension would be maintained at a similar level as the lever was moved up and down over a range of motion, the lever will tend to stay locked in place until it is rotated far enough to beginning removing the tension, but absent a force the lever will stay in place as there is no advantage to it moving. Thus, a letoff portion in this embodiment may have the same radius over a portion of its rotation. That is, as the lever is moved down, for a time the tension increases (the distance between the fulcrum and the outer edge of the lever that is at that moment in contact with the aquarium device is increasing, adding tension) until it reaches a portion that is rounded, and in which the distance between the fulcrum 350 and the outer edge remains constant, thus providing a constant amount of tension.

The adjustable locking fastener may be made of materials suitable for use in the aquarium. Plastics would be preferably food grade, such that materials will not leach into the aquarium harming the livestock. Water resistant materials such as plastics, especially food grade plastics, PVC, ABS, stainless steel, epoxies, carbon fiber, silicon, acrylics, PET, PTFE, Nylon, injection molded plastics, aluminum (anodized or not anodized), powder coated materials, etc. are appropriate materials. The material used may be the same as that used in the aquarium device. For example, a calcium reactor made of acrylic may utilize an acrylic adjustable locking fastener. In embodiments, the adjustable locking fastener is colored to make the parts easy to see. An orange, or glow in the dark fastener will be easier to work with, line up, and use in a dark environment underneath an aquarium. Likewise, many aquariums use UV lighting for various purposes, and as such a UV reactive material, e.g. one that will fluoresce under UV lighting, may be preferred.

1. An adjustable locking fastener for use in an aquarium comprising:
a post, the post constructed entirely of aquarium safe materials and comprising
a shaft and a head
a lever, the lever comprising
a first and a second protrusion with a gap between them, the gap sized to accommodate the post;
a first raised portion, a second raised portion, and a depression between the first and second raised portion, the depression sized to accommodate the head; and
a letoff portion.

2. The adjustable locking fastener of claim 1, wherein the letoff portion is rounded.

3. The adjustable locking fastener of claim 1, wherein the letoff portion is flat

4. The adjustable locking fastener of claim 3 wherein the flat letoff portion has a different axis than the lever.

5. The adjustable locking fastener of claim 1, wherein the post and the lever are constructed of a reef safe material.

6. The adjustable locking fastener of claim 5, wherein the reef safe material is injection molded plastic.

7. The adjustable locking fastener of claim 5, wherein the reef safe material fluoresces under UV light.

8. The adjustable locking fastener of claim 1, wherein the head includes a tightening means.

9. The adjustable locking fastener of claim 1, wherein the head includes a recess.

10. The adjustable locking fastener of claim 1, wherein the depression is sized to hold the head.

11. The adjustable locking fastener of claim 10, wherein the depression is shaped to provide a letoff when the head is fully seated inside the depression.

12. The adjustable locking fastener of claim 10, wherein the depression surrounds the head.

13. The adjustable locking fastener of claim 10, wherein the depression partially surrounds the head.

14. The adjustable locking fastener of claim 1, wherein the lever is configured to rotate from a first position to a second position.

15. The adjustable locking fastener of claim 14, wherein the lever is configured to increase the tension on the post as it rotates from a first position to a second position.

16. The adjustable locking fastener of claim 15, wherein the letoff portion is configured to reduce the tension on the post at the end of a lever rotation.

17. An adjustable locking fastener for use in an aquarium comprising:
a post, the post constructed entirely of aquarium safe materials and comprising
a shaft and a head
a lever, the lever comprising
a first and a second protrusion with a gap between them, the gap sized to accommodate the post;
a first raised portion, a second raised portion, and a depression between the first and second raised portion, the depression sized to accommodate the head; and
a letoff portion, wherein the letoff portion is configured to retain a constant tension on the post during a portion of a lever rotation.

18. The adjustable locking fastener of claim 17, wherein the lever comprises a detachable tool, the detachable tool configured to tighten or loosen the post.
